(19) United States
(12) Patent Application Publication
(10) Pub. No.: US 2012/0221958 A1
(43) Pub. Date: Aug. 30, 2012

(54) COMPUTER SYSTEM AND METHOD FOR CONTROLLING COMPUTER

(75) Inventor: Fan Xu, Tokyo (JP)

(73) Assignee: Hitachi, Ltd.

(21) Appl. No.: 13/130,190

(22) PCT Filed: Feb. 25, 2011
(86) PCT No.: PCT/JP2011/054362

§ 371 Date: May 19, 2011

(51) Int. Cl. G06F 3/01; G06F 15/16

(52) U.S. Cl. 715/740

(57) ABSTRACT

It is provided a computer system, including: an operating terminal operated by a user; and at least one remote terminal controlled remotely by the operating terminal. The computer system holds a generation rule for generating a control command from operation information input by the user. The computer system obtains operation information generated by the user; generates a control command from the obtained operation information following the generation rule; and transmits the generated control command to the at least one remote terminal. The at least one remote terminal includes executes the received control command, and transmits a result of executing the received control command to the operating terminal. The operating terminal receives the execution result transmitted from the at least one remote terminal, and determines from the received execution result whether the execution of the control command is a success or a failure.

### BACKGROUND

This invention relates to a computer system including an operating terminal, which is operated by a user, and a remote terminal, which is controlled remotely.

In a computer system that includes an operating terminal and remotely controls another computer (remote terminal) located in a remote site, a display of the operating terminal displays the same info illation that is displayed on a display of the remote terminal, and an operation made by a user on the operating terminal is really executed on the remote terminal. With this conventional remote control, what is displayed on the display of the remote terminal in the remote site is displayed on the display of the operating terminal by transferring display screen information from the remote terminal to the operating terminal. Screen drawing data having a large capacity therefore needs to be transferred. The conventional remote control also involves transfer from the operating terminal to the remote terminal of information about an operation made by the user on the screen of the operating terminal with the use of a keyboard and a mouse (operation input information).

JP 2001-229108 A discloses a technology as related art of this type of remote control in which an operation made on the screen of an arbitrarily selected remote terminal is transmitted to a plurality of other remote terminals.

### SUMMARY

This related art requires screen information of a remote terminal to execute remote control operation. Screen information is large in data amount as described above and, when a communication line between an operating terminal and a remote terminal has a small capacity, the large data size makes it difficult for the operating terminal to follow and reflect the screen activity of the remote terminal and hinders smooth operation on the operating terminal. The same problem arises when the number of remote terminals to be controlled is large.

A representative aspect of this invention is as follows. That is, there is provided a computer system, including: an operating terminal which is operated by a user; and at least one remote terminal which is controlled remotely by the operating terminal. The operating terminal includes a processor which executes a program, a memory which stores the program executed by the processor, a user interface, and a communication interface. The at least one remote terminal includes a processor which executes a program, a memory which stores the program executed by the processor, and a communication interface. The computer system holds a generation rule for generating a control command from operation information input by the user. The computer system further includes: an operation information obtaining module which obtains operation information generated by the user by operating the user interface; a command generating module which generates a control command from the obtained operation information following the generation rule; and a command transmitting module which transmits the generated control command to the at least one remote terminal. The at least one remote terminal includes a command executing module, which executes the received control command, and an execution result transmitting module, which transmits a result of executing the received control command to the operating terminal. The operating terminal includes an execution result receiving module, which receives the execution result transmitted from the at least one remote terminal, and determines from the received execution result whether the execution of the control command is a success or a failure.

According to the representative aspect of this invention, the amount of data transferred between terminals is reduced.

### BRIEF DESCRIPTION OF THE DRAWINGS

The present invention can be appreciated by the description which follows in conjunction with the following figures, wherein:

FIG. 1 is a diagram illustrating an example of a configuration of a computer system according to a first embodiment of this invention;

FIG. 2A is a block diagram illustrating an example of a configuration of an operating terminal according to the first embodiment of this invention;

FIG. 2B is a block diagram illustrating an example of a configuration of a remote terminal according to the first embodiment of this invention;

FIG. 3 is a diagram illustrating an example of an operation information list according to the first embodiment of this invention;

FIG. 4 is a diagram illustrating an example of generation rules according to the first embodiment of this invention;

FIG. 5 is a diagram illustrating an example of a generated script according to the first embodiment of this invention;

FIGS. 6A and 6B are flow charts of an example of remote control operation processing executed by an operating terminal according to the first embodiment of this invention;

FIG. 7 is a flow chart of an example of remote control operation processing executed by a failed remote terminal according to the first embodiment of this invention;

FIG. 8 is a block diagram illustrating an example of a configuration of a computer system according to a second embodiment of this invention;

FIG. 9 is a diagram illustrating an example of terminal information according to the second embodiment of this invention;

FIG. 10 is a flow chart of an example of remote control operation processing according to the second embodiment of this invention;

FIG. 11A is a block diagram illustrating an example of a configuration of a computer system which focuses on an operating terminal according to a third embodiment of this invention;

FIG. 11B is a block diagram illustrating an example of a configuration of the computer system which focuses on a representative terminal according to the third embodiment of this invention;

FIG. 12 is a diagram illustrating an example of a terminal information according to the third embodiment of this invention;

FIG. 13 is a flow chart of an example of remote control operation processing that is executed by the operating terminal according to the third embodiment of this invention;

FIG. 14 is a flow chart of an example of remote control operation processing that is executed by the representative terminal according to the third embodiment of this invention;

FIG. 15 is a diagram illustrating an example of a screen that is displayed on a display of the operating terminal according to the third embodiment of this invention;

FIG. 16A is a block diagram illustrating an example of a configuration of a computer system which focuses on an operating terminal according to the fourth embodiment of this invention;

FIG. 16B is a block diagram illustrating an example of a configuration of the computer system which focuses on a representative terminal according to the fourth embodiment of this invention;

FIG. 17 is a flow chart of an example of remote control operation processing that is executed by the operating terminal according to the fourth embodiment of this invention; and

FIG. 18 is a block diagram illustrating an example of a configuration of a computer system according to the fifth embodiment of this invention.

### DETAILED DESCRIPTION OF THE PREFERRED EMBODIMENTS

Embodiments of this invention are described below with reference to the drawings. A first embodiment in which an operating terminal operated by a user and a remotely controlled remote terminal are provided on a one-on-one basis is described first. Described next are second to fourth embodiments in which a plurality of remote terminals is provided for one operating terminal. Lastly, a fifth embodiment in which a distribution server is provided is described.

### First Embodiment

In the first embodiment of this invention, an operating terminal 101 and an remote terminal 121 are provided on a one-on-one basis.

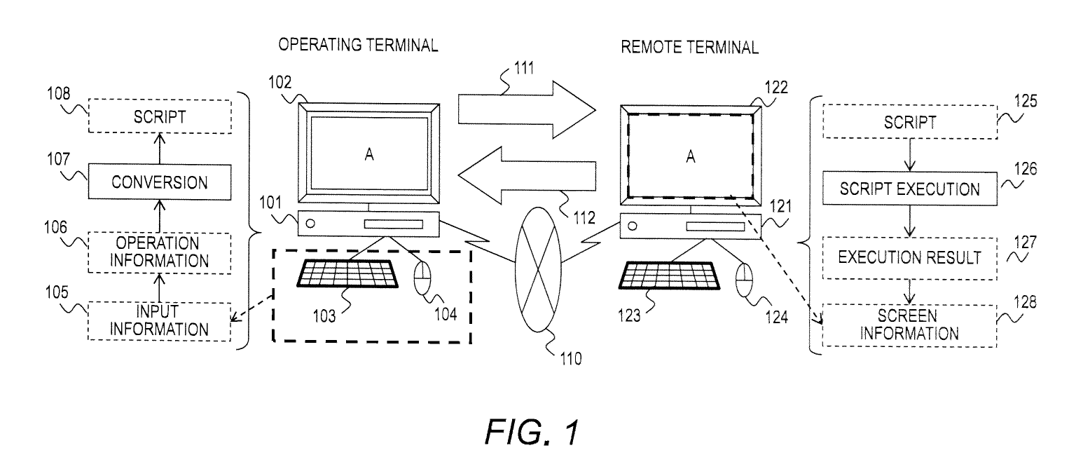

FIG. 1 is a diagram illustrating an example of the configuration of a computer system according to the first embodiment.

The computer system of the first embodiment includes the operating terminal 101, which is operated by a user, and the remote terminal 121, which is controlled remotely by the operating terminal 101. The operating terminal 101 and the remote terminal 121 may be general-purpose personal computers or specially designed terminals.

The operating terminal 101 and the remote terminal 121 are coupled via a network 110. The network 110 may be a LAN or other private networks, or may be a public wireless communication network such as a wireless LAN, a cellular phone network, and a Personal Handy-phone System (PHS) network.

A display 102, a keyboard 103, and a mouse 104 are connected to the operating terminal 101 to constitute a user interface. The display 102 displays a screen to be notified to the user following an instruction from the operating terminal 101. The keyboard 103 and the mouse 104 are operated by the user and receive an instruction to be input to the operating terminal 101.

Similarly, a display 122, a keyboard 123, and a mouse 124 are connected to the remote terminal 121. The display 122, the keyboard 123, and the mouse 124 may not be connected to the remote terminal 121 because the remote terminal 121 is controlled remotely by the operating terminal 101.

With conventional remote control, the display 102 of the operating terminal 101 displays the same screen as on the display 122 of the remote terminal 121, and an operation input to the keyboard 103 and mouse 104 of the operating terminal 101 is reproduced on the remote terminal 121. The conventional remote control involves transmitting input information from the operating terminal 101 to the remote terminal 121 (111), and transmitting screen information from the remote terminal 121 to the operating terminal 101 (112).

With remote control according to this embodiment, the operating terminal 101 converts operation information 106 into a script 108 (107). The operation information 106 is obtained from input information 105, which is generated by operating the keyboard 103 and the mouse 104. The operating terminal 101 transmits the script 108 to the remote terminal 121 (111). The remote terminal 121 executes a script 125 transmitted from the operating terminal 101 (126), to thereby reproduce an operation made on the operating terminal 101, and sends a script execution result 127 to the operating terminal 101 in response.

The remote terminal 121 also generates, from the script execution result 127, screen information 128 for displaying the result of processing the script on the display 122. The screen information 128 is transmitted to the operating terminal 101 in order to enable the user to confirm the action of the remote terminal 121 on the operating terminal 101 (112). In this embodiment, where the screen information 128 is generated from the script execution result 127, the screen information 128 may not be transmitted to the operating terminal 101.

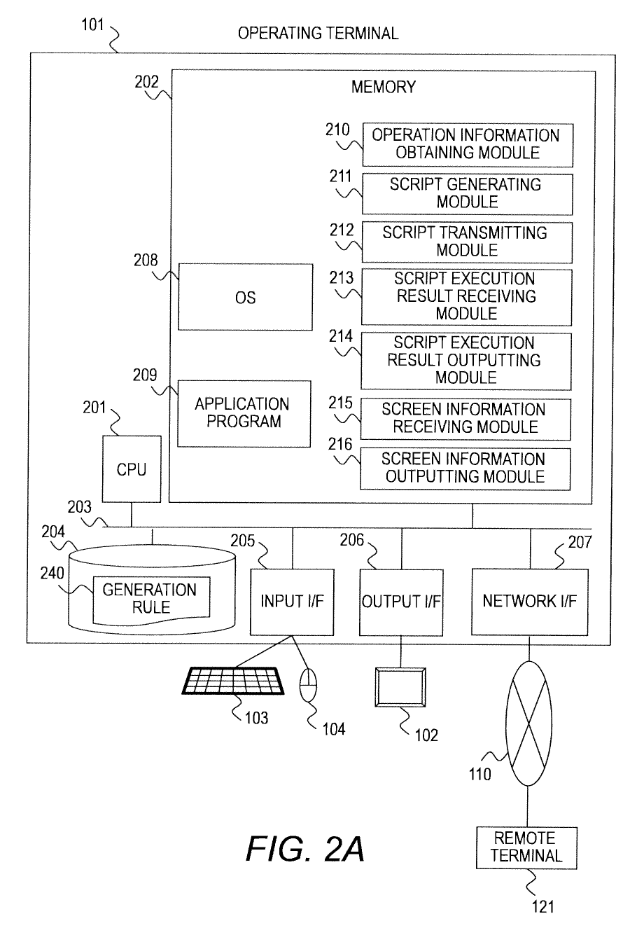

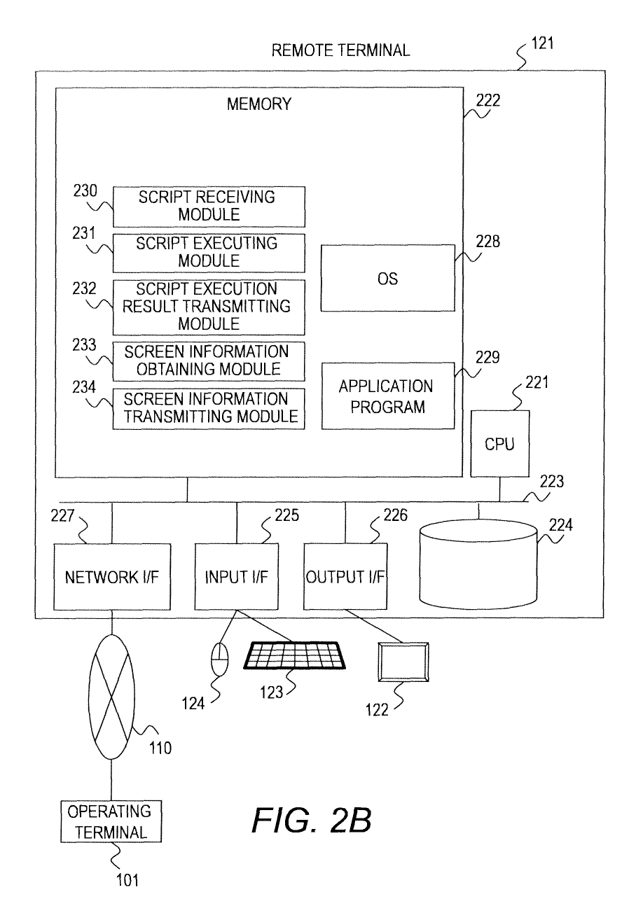

FIG. 2A is a block diagram illustrating an example of the configuration of the operating terminal 101 according to the first embodiment.

The operating terminal 101 is a computer that includes a processor (CPU) 201, a memory 202, a bus 203, a non-volatile storage device 204, an input interface 205, an output interface 206, and a network interface 207.

The memory 202 is a high-speed volatile storage device such as a dynamic random access memory (DRAM). The memory 202 stores an operating system (OS) 208 and an application program 209. The processor 201 executes the operating system 208 to implement basic functions of the operating terminal 101, and executes the application program 209 to install functions that the operating terminal 101 provides to the user.

The memory 202 also stores programs that constitute an operation information obtaining module 210, a script generating module 211, a script transmitting module 212, a script execution result receiving module 213, a script execution result outputting module 214, a screen information receiving module 215, and a screen information outputting module 216. In other words, the processor 201 executes these programs to install the modules listed above.

The operation information obtaining module 210 obtains a window message that is generated by the OS 208 or the application program 209 and transmitted to a window, and a window message that is generated by the user's operation (an operation instruction input to the keyboard 103 and the mouse 104). The operation information obtaining module 210 extracts from the obtained window messages the details of the operation, the value of the operation, and information on the target of the operation (the hierarchy information of the window, the class name of the window, the title of the window, and the like), and stores the extracted operation information 106 in a given storage area.

The script generating module 211 converts operation information extracted by the operation information obtaining module 210 into the script 108 based on generation rules 240, and stores the generated script 108 in a given storage area. The script transmitting module 212 transmits a script generated by the script generating module 211 to the remote terminal 121.

The script execution result receiving module 213 receives execution result information transmitted from the remote terminal 121. The script execution result outputting module 214 generates data for displaying the received execution result information on the display 102.

The execution result information transmitted from the remote terminal 121 is the result of executing a script on the remote terminal and contains the success/failure of the execution of the script, the presence/absence of an error, and details of the error. Error details include information for identifying a place where the execution of the script has failed (for example, “Item BBB of Operation AAA is not found”).

The screen information receiving module 215 receives screen information transmitted from the remote terminal 121. The screen information outputting module 216 generates data for displaying the received screen information on the display 102.

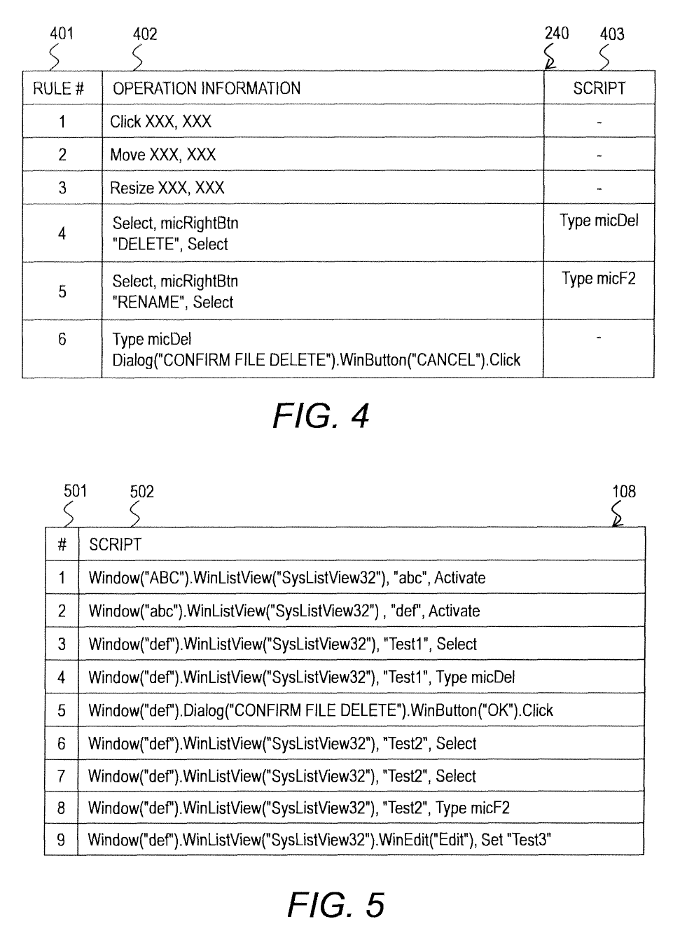

The non-volatile storage device 204 is a large-capacity non-volatile storage device such as a magnetic storage device or a flash memory, and stores the generation rules 240. The generation rules 240 are used to generate a script 403 from operation information 402. The configuration of the generation rules 240 is described later with reference to FIG. 4.

FIG. 2B is a block diagram illustrating an example of the configuration of the remote terminal 121 according to the first embodiment.

The remote terminal 121 is a computer that includes a processor (CPU) 221, a memory 222, a bus 223, a non-volatile storage device 224, an input interface 225, an output interface 226, and a network interface 227.

The memory 222 is a high-speed volatile storage device such as a dynamic random access memory (DRAM). The non-volatile storage device 224 is a large-capacity non-volatile storage device such as a magnetic storage device or a flash memory.

The memory 222 stores an operating system (OS) 228 and an application program 229. The processor 221 executes the operating system 228 to implement basic functions of the remote terminal 121, and executes the application program 229 to install functions that the remote terminal 121 provides to the user.

The memory 222 also stores programs that constitute a script receiving module 230, a script executing module 231, a script execution result transmitting module 232, a screen information obtaining module 233, and a screen info illation transmitting module 234. In other words, the processor 221 executes these programs to install the modules listed above.

The script receiving module 230 receives the script 125 transmitted from the operating terminal 101 and stores the received script 125 in a given storage area. The script executing module 231 processes the script 125 received by the script receiving module 230, and stores the execution result (success/error (including details of the error)) 127 of the script 125 in a given storage area.

The script execution result transmitting module 232 transmits the script execution result 127 to the operating terminal 101. A script execution result contains information about the success/failure of the execution of the script and details of the error. The OS 228 generates data for displaying a script execution result on the display 122.

The screen information obtaining module 233 obtains the screen information 128 which is information of a screen being displayed on the display 122, and stores the obtained screen information 128 in a given storage area. The screen information transmitting module 234 transmits the screen information 128 obtained by the screen information obtaining module 233 to the operating terminal 101.

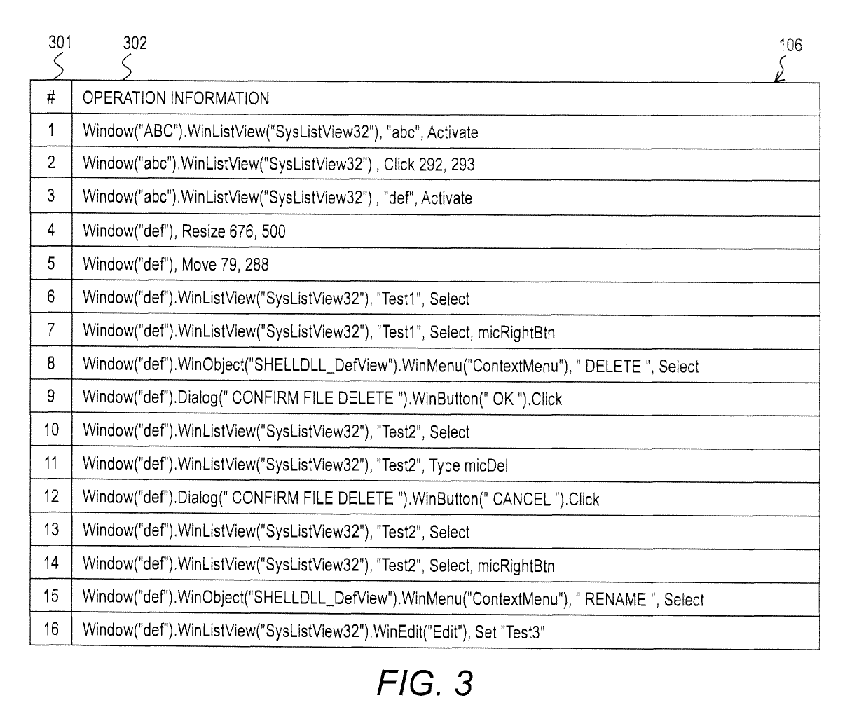

FIG. 3 is a diagram illustrating an example of an operation information list in which operation information is recorded according to the first embodiment.

FIG. 3 illustrates sixteen-row operation information with a series of sixteen operations by the user recorded in their respective rows. For example, the first row indicates that an “activate” operation has been executed for an item “abc” which is included in a child window “SysListView32” under a parent window “ABC.” In the first row, Window(“ABC”).WinListView(“SysListView32”) represents the hierarchical structure of the operation target window, Window and WinListView are each the class name of a window, “ABC” and “SysListView32” are each the title of a window, “abc” is the value of the operation executed, and Activate represents the operation executed.

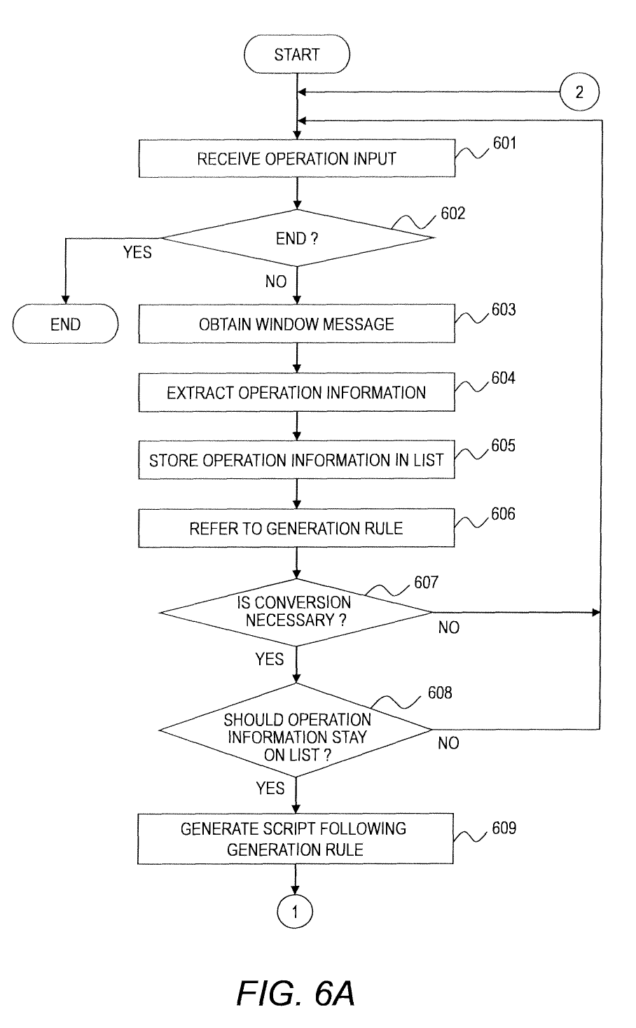

FIG. 4 is a diagram illustrating an example of the generation rules 240 according to the first embodiment. FIG. 5 is a diagram illustrating an example of a script that is generated from the operation information of FIG. 3 based on the generation rules 240 of FIG. 4.

The generation rules 240 of FIG. 4 each hold an association relation between a piece of operation information 402 and the script 403 that is generated from that piece of operation information 402. A rule number 401 is a unique number assigned to each generation rule.

Rules 1, 2, and 3 of FIG. 4 are rules for deleting operation information that has no other ongoing actions, with parameters of the operation information 402 indicating coordinates. For example, in the case of operation information such as “Click XXX, XXX,” “Move XXX, XXX,” and “Resize XXX, XXX” (XXX are numbers indicating coordinates on the screen) which respectively indicate that a click has been made on the screen, that the window has been moved, and that the size of the window has been changed, no scripts are defined in association with the operation information. In other words, operation information for which “−” is written in its script field is not converted into a script and is deleted at the time of conversion from operation information into a script.

This is because an operation indicated by operation information that does not yield any other results than a change on the screen does not need to be executed on the remote terminal 121, and is also to prevent an operation made at a set of coordinates on the operating terminal 101 from turning into a different operation at the same set of coordinates on the remote terminal 121 when a difference in screen size between the operating terminal 101 and the remote terminal 121 causes a difference in coordinates on the screen. Based on these rules, pieces of operation information in Rows 2, 4, and 5 of FIG. 3 are deleted.

A user's operation made with a mouse can generally be made with a keyboard as well. Rules 4 and 5 of FIG. 4 are rules for translating operation information about a mouse operation that can be executed efficiently and accurately by operating a keyboard into a simpler keyboard operation. As in Rules 4 and 5, an operation of selecting an item, displaying a menu with a right click of the mouse, and selecting “delete” processing from the menu is translated into a keyboard operation “Type micDel” by which the same effect is obtained. Similarly, an operation of selecting “rename” processing from the menu is translated into a keyboard operation “Type micF2.”

Based on these rules, pieces of operation information in Rows 7 and 8 of FIG. 3 are converted into a script in Row 4 of FIG. 5, and pieces of operation information in Rows 14 and 15 of FIG. 3 are converted into a script in Row 8 of FIG. 5.

Rule 6 of FIG. 4 is a rule for deleting an operation that is not actually executed. For example, in the case where canceling an operation is chosen during the confirmation of the execution of the operation, this operation (operation preceding the cancel operation) is not executed. Specifically, as in Rule 6, when a delete operation is canceled by clicking on “cancel” in a confirmation dialogue for the delete operation, the cancel operation and the delete operation preceding the cancel operation are deleted. Based on this rule, pieces of operation information in Rows 11 and 12 of FIG. 3 are deleted.

The nine-row script 108 of FIG. 5 is generated from the sixteen-row operation information 106 of FIG. 3 based on the generation rules 240 of FIG. 4. The script 108 generated from the control information 106 is transmitted to the remote terminal 121, thereby reducing the amount of data that is sent from the operating terminal 101 to the remote terminal 121.

The generation rules 240 are not limited to the example of FIG. 4, and items may be added to or removed from the illustrated generation rules.

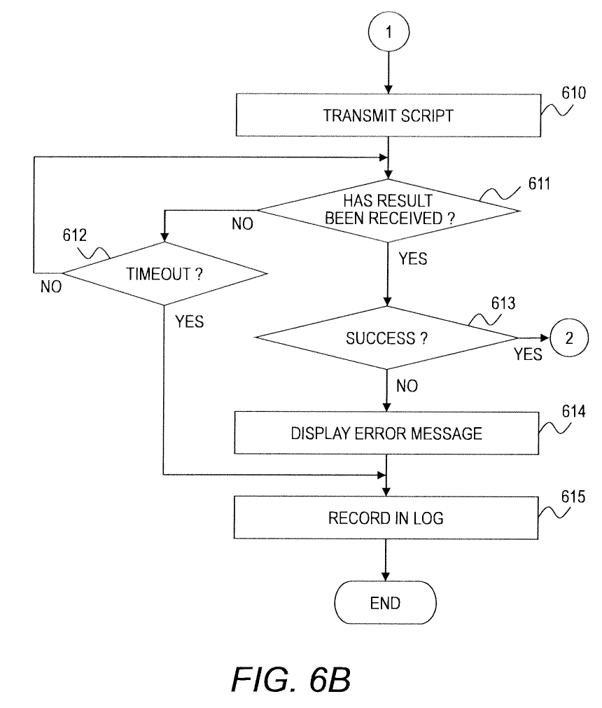

FIGS. 6A and 6B are flow charts of an example of remote control operation processing that is executed by the operating terminal 101 according to the first embodiment.

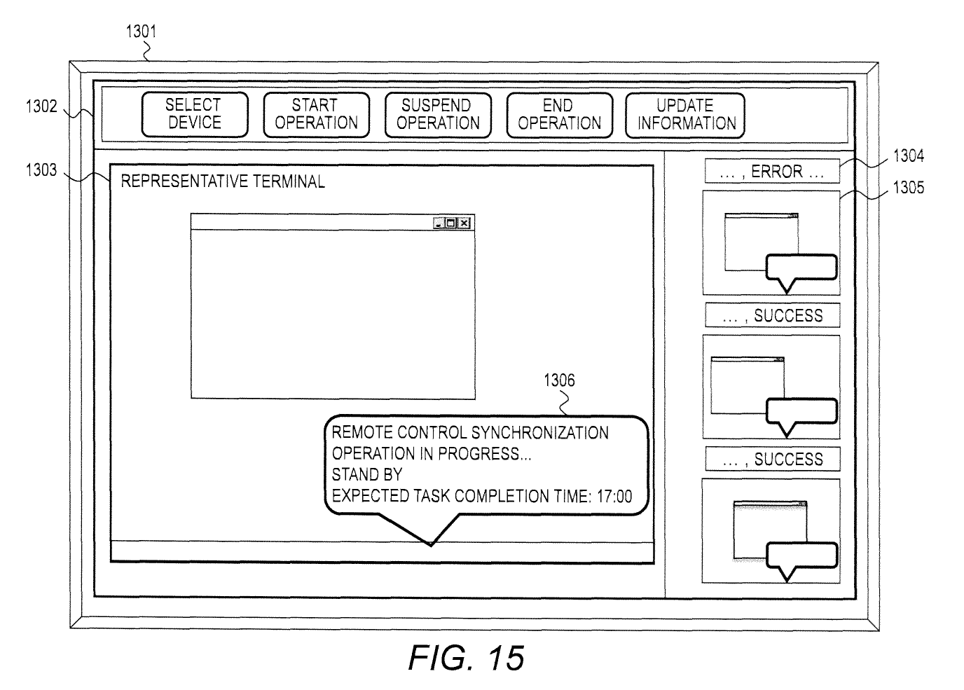

First, an operation input to the keyboard 103 or the mouse 104 by the user is detected (601), and then the operation information obtaining module 210 obtains a window message from the operation input (603). When the operation information obtaining module 210 detects the end of the remote control operation processing, the remote control operation processing is terminated (602). The end of the remote control operation processing is signaled by, for example, the operation of selecting an “end operation” button illustrated in FIG. 15, the operation of closing a remote control window, or timeout in which no operation has been made for a given period of time.

The operation information obtaining module 210 extracts the operation information 106 from the obtained window message (604), and stores the extracted operation information 106 in an operation information list as illustrated in FIG. 3 (605). The operation information list generated in Step 605 may be a window-basis list or may be a single list instead of being divided by window.

The script generating module 211 refers to the generation rules 240 to determine whether or not the operation information 106 stored in the operation information list needs to be converted and whether or not this operation information should stay on the list (607 and 608). The need to convert the operation information 106 stored in the list is determined by whether or not this operation information is defined in the field for the operation information 402 in one of the generation rules 240. It is determined that the operation information 106 stored in the list should stay on the list when this operation information is defined in the field for the operation information 402 in one of the generation rules 240, and no script 403 is defined in association with this operation information.

From the operation information 106 that has been determined to need conversion and to be left on the list, the script generating module 211 generates the script 108 following the relevant generation rule 240 (609).

The script transmitting module 212 transmits the script 108 generated by the script generating module 211 to the remote terminal 121, and activates a timer with which the script execution result receiving module 213 determines timeout (610).

The script execution result receiving module 213 receives a script execution result sent from the remote terminal 121 in response (611), and determines whether the execution of the script has succeeded or failed (613). In the case where a script execution result is not received before the timer registers timeout, there is a fear that the script has not been executed due to a power loss of the remote terminal 121 or for other reasons, and therefore the occurrence of timeout is recorded in a log (615).

When the execution of the script is a success, the processing returns to Step 601 in order to obtain next operation information on the operation information list. When the execution of the script is a failure, on the other hand, the script execution result outputting module 214 displays an error message (614), and records the error in the log (615). A success of script execution may be recorded in the log as well. With the log recording errors, the cause of a script execution failure can be identified.

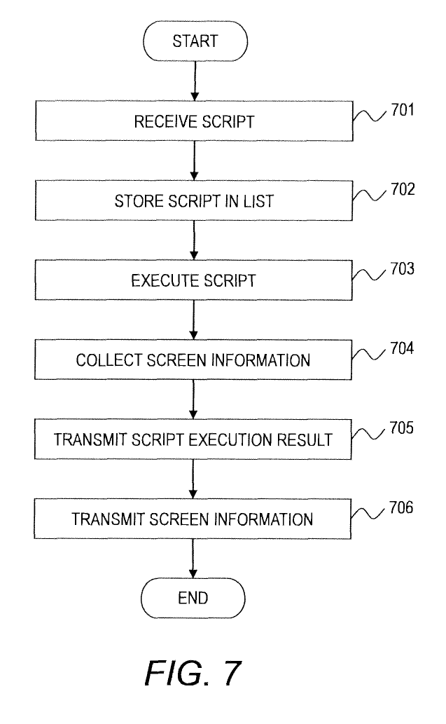

FIG. 7 is a flow chart of an example of remote control operation processing that is executed by the failed remote terminal 121 according to the first embodiment.

The script receiving module 230 receives a script from the operating terminal 101 (701) and stores the received script in a list (702). The script executing module 231 executes the script stored in the list (703).

The screen information obtaining module 233 obtains the screen information 128 that results from the execution of the script (704), and the screen information transmitting module 234 transmits the obtained screen information 128 to the operating terminal 101 (706).

The script execution result transmitting module 232 transmits the script execution result 127 to the operating terminal 101 (705). The script execution result transmitting module 232 may transmit the script execution result 127 one script row at a time, or may transmit the script execution result 127 at once after the execution of the entire script is finished.

The order in which Steps 704 to 706 are executed is not limited to the illustrated one, and the processor 221 may execute the processing of the screen information 128 and the processing of the script execution result 127 in parallel.

When a script execution result that indicates an error is received, the script execution result receiving module 213 of the operating terminal 101 stops the action of the operation information obtaining module 210, to thereby cease remote control. Alternatively, the script execution module 231 may re-execute the script of which execution has failed, immediately or after a given period of time, or the action of the script executing module 231 may be stopped.

When an execution error is detected, recovery from the error can be accomplished by the following method.

Specifically, at the time an execution error is detected, which row in the script has experienced the error and details of the error are obtained first. Thereafter, in the case where this script is to be started in the failed remote terminal 121, the script is resumed from the row where the error has been detected.

To give a concrete description on error and recovery procedures, when an operation target “Test1” is not found in the remote terminal 121 where the third row in the script of FIG. 5, Window(“def”).WinListView(“SysListView32”), “Test1”, Select, is being executed, the failed remote terminal 121 issues an error message “operation target is not found” as an execution result of this script.

The script execution result receiving module 213 of the operating terminal 101 in this case receives from the failed remote terminal 121 the number of a row in the script where the error has occurred and the error message “operation target is not found,” and stores the received error details in a given area of the memory. The script executing module 231 then transmits the failed row and subsequent rows of the script again to the failed remote terminal 121 in order to re-activate (re-execute) the script from the failed row.

To give another concrete example, an example of recovery from a connection error is described.

First, at the time a connection error is detected, the connection destination remote terminal 121 where the error has occurred, which row in a script that has been executed in the failed remote terminal has experienced the error, and details of the error are obtained, and the obtained failed row and error details are displayed. When connection is to be made again, re-connection of the failed remote terminal 121 is attempted and, once the connection is established successfully, the row where the error has been detected and the subsequent rows of the script are transmitted again.

To give a concrete description on error and recovery procedures, when an error that “remote controller 1 is not found” occurs in the remote terminal 121 where the third row in the script of FIG. 5, Window(“def”).WinListView(“SysListView32”), “Test1”, Select, is being transmitted, the failed remote terminal 121 issues an error code “connection to the remote terminal cannot be made.”

The script execution result receiving module 213 of the operating terminal 101 in this case receives the number of a row in the script where the connection error has occurred and the error message “connection to the remote terminal cannot be made,” and stores the received error details in a given area of the memory. The script executing module 231 then tries to re-connect to the failed remote terminal 121 and, when the re-connection is successful, transmits the failed row and subsequent rows of the script again.

As described above, according to the first embodiment, a script that is generated by compressing the amount of information of an operation input to the operating terminal 101 is transmitted, thereby cutting down the amount of data transferred between terminals and reducing the traffic between terminals. In addition, there is no need to transmit screen information of the remote terminal 121 to the operating terminal 101, which further cuts down the amount of data transferred between terminals and reduces the traffic between terminals.

Another advantage is that operation on the operating terminal 101 does not depend on coordinates on the screen of the remote terminal 121, which enables the computer system to perform remote control when screen information of the remote terminal is not transferred or when the computer system includes a plurality of remote terminals and screen information varies from one remote terminal from another.

Moreover, because a script execution result is transmitted from the remote terminal 121 to the operating terminal 101, the cause of failure of the execution of a script is provided, which helps to improve the efficiency of remote control operation.

### Second Embodiment

A second embodiment discusses an example of remote control operation in a computer system that includes a plurality of remote terminals.

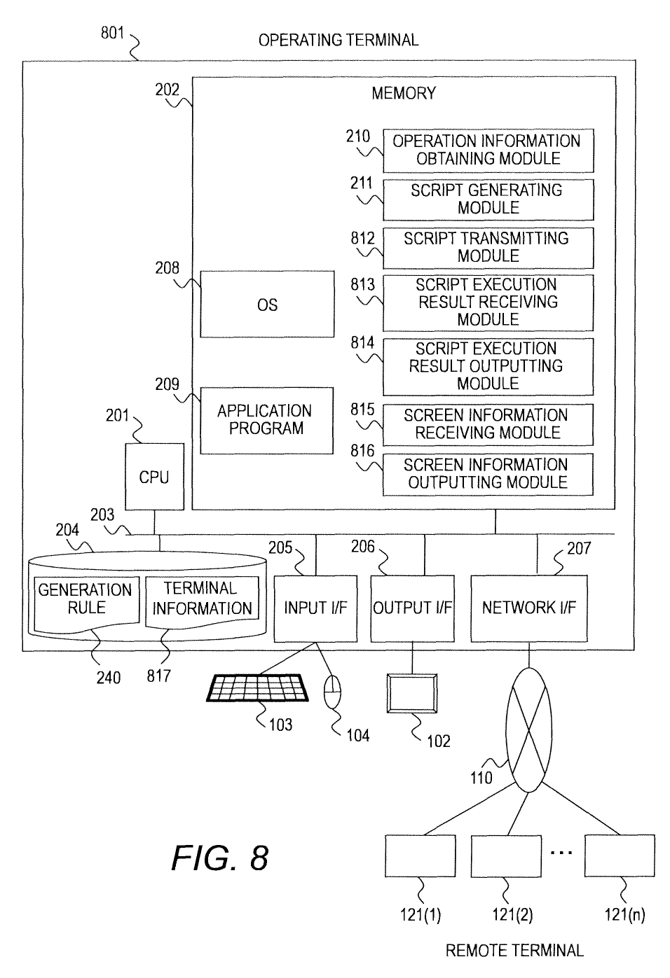

FIG. 8 is a block diagram illustrating an example of a configuration of a computer system according to the second embodiment which focuses on an operating terminal 801. In the second embodiment, components and processing that have the same functions as those in the first embodiment are denoted by the same reference symbols, and descriptions thereof are omitted.

The computer system of the second embodiment includes one operating terminal 801, which is operated by a user, and a plurality of remote terminals 121(1) to 121(n), which are controlled remotely by the operating terminal 801. The operating terminal 801 and the remote terminals 121(1) to 121(n) are coupled to each other via the network 110.

The operating terminal 801 is a computer that includes the processor (CPU) 201, the memory 202, the bus 203, the non-volatile storage device 204, the input interface 205, the output interface 206, and the network interface 207. The operating terminal 801 may be a general-purpose personal computer or a specially designed terminal. The remote terminals 121(1) to 121(n) are each the same as the remote terminal 121 of the first embodiment.

The operating terminal 801 is a computer that includes the processor (CPU) 201, the memory 202, the bus 203, the non-volatile storage device 204, the input interface 205, the output interface 206, and the network interface 207. The operating terminal 801 is connected to the display 102, the keyboard 103, and the mouse 104.

The memory 202 stores the operating system (OS) 208 and the application program 209.

The memory 202 also stores programs that constitute the operation information obtaining module 210, the script generating module 211, a script transmitting module 812, a script execution result receiving module 813, a script execution result outputting module 814, a screen information receiving module 815, and a screen information outputting module 816. In other words, the processor 201 executes these programs to install the modules listed above.

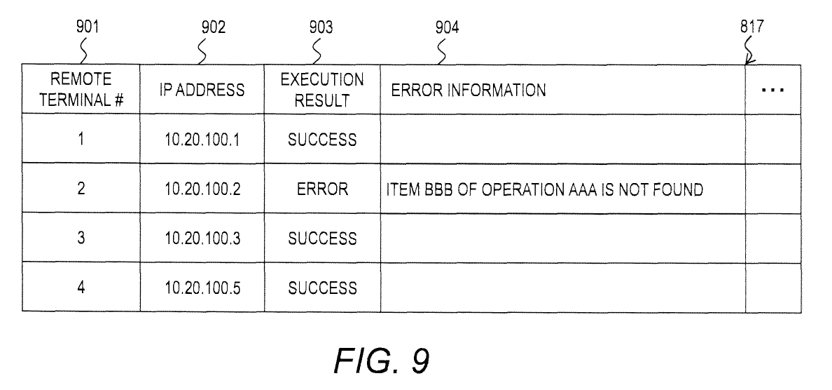

The script transmitting module 812 refers to terminal information 817 illustrated in FIG. 9 to transmit a script obtained through conversion by the script generating module 211 to the plurality of remote terminals 121(1) to 121(n).

The script execution result receiving module 813 receives execution result information transmitted from the plurality of remote terminals 121(1) to 121(n). The script execution result outputting module 814 generates data for displaying the received execution result information on the display 102.

The screen information receiving module 815 receives screen information transmitted from the plurality of remote terminals 121(1) to 121(n). The screen information outputting module 816 generates data for displaying the received screen information on the display 102.

The non-volatile storage device 204 stores the generation rules 240 and the terminal information 817. The terminal information 817 holds information of the remote terminals 121(1) to 121(n) with which the operating terminal 801 communicates. The configuration of the terminal information 817 is described later with reference to FIG. 9.

FIG. 9 is a diagram illustrating an example of the terminal information 817 according to the second embodiment.

The terminal information 817 is information referred to when the operating terminal 801 communicates with the remote terminals 121(1) to 121(n), and contains in each entry an remote terminal number 901, an IP address 902, an execution result 903, and error information 904.

The remote terminal number 901 is a unique number assigned to each entry where information of an remote terminal is stored. The IP address 902 is a network address assigned to the entry's remote terminal. Depending on the network configuration, other addresses may be stored in place of the IP address 902.

The execution result 903 is the result of executing a script on the remote terminal. As the execution result 903, “Success” is stored when a script is executed successfully and “Error” is stored when the execution of a script fails. The error information 904 indicates details of an error when the execution result 903 is “Error,” and contains information for identifying a place where the execution of a script has failed (for example, “Item BBB of Operation AAA is not found”).

In this embodiment, in order to reduce the amount of data transferred over the network 110, the terminal information 817 is not transferred between the operating terminal 801 and the remote terminals 121(1) to 121(n). However, the terminal information 817 may be shared between the operating terminal 801 and the remote terminals 121(1) to 121(n) by transferring the terminal information 817 that is created by one of the operating terminal 801 and the remote terminals 121(1) to 121(n) to the other.

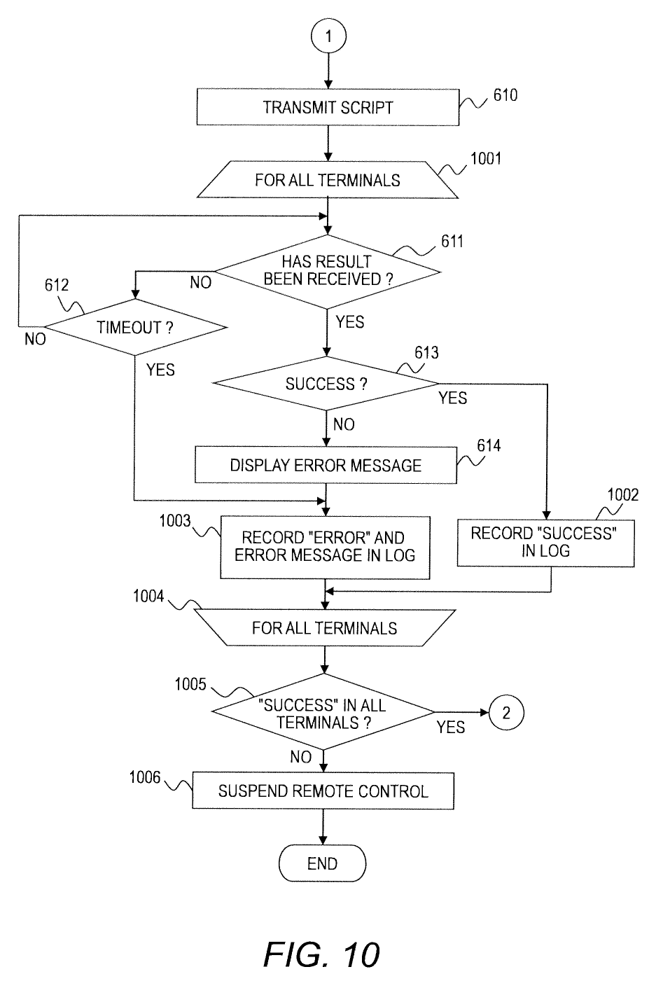

FIG. 10 is a flow chart of an example of remote control operation processing according to the second embodiment. The remote control operation processing illustrated in FIG. 10 is executed after Step 609 of FIG. 6A. The same steps as those in the remote control operation processing of the first embodiment illustrated in FIGS. 6A and 6B are denoted by the same reference symbols, and descriptions thereof are omitted here.

In the remote control operation processing of the second embodiment, a series of processing steps including the transmission of a script and the reception of a script execution result is executed after Step 609 for all relevant terminals out of the remote terminals 121(1) to 121(n).

Specifically, the script transmitting module 812 refers to the terminal information 817 to identify the IP address of an remote terminal to which a script is to be sent, and transmits the script to the identified address (610). In the case where the remote terminals alone are connected to the network, a script may be broadcast to be transmitted simultaneously to a plurality of remote terminals.

Next, execution result receiving processing is executed for every remote terminal that has been identified by referring to the terminal information 817 (1001, 611 to 614, and 1002 to 1004). When it is found as a result of Steps 611 to 613 that the execution of the script has failed, the script execution result outputting module 814 displays an error message (614), and records the execution result (Error) transmitted from the remote terminal and the error message in the terminal information (log) 817 (1003). When the execution of the script has succeeded, on the other hand, the script execution result outputting module 814 records the execution result (Success) transmitted from the remote terminal in the terminal information (log) 817 (1002).

In this embodiment, a script execution result (log) is recorded in the terminal information 817. Alternatively, an execution result log may be provided separately from the terminal information to record a script execution result in the execution result log separate from the terminal information.

When an execution result that indicates a success is subsequently received from all relevant terminals out of the remote terminals 121(1) to 121(n) (YES in 1005), the processing returns to Step 601 illustrated in FIG. 6A in order to obtain the next piece of operation information on the operation information list. When an execution result that indicates a failure is received from some of the remote terminals 121(1) to 121(n) (NO in 1005), on the other hand, remote control is suspended (1006). Remote control may be suspended only for an remote terminal that has failed in the execution of a script by setting the computer system such that the success of script execution in every remote terminal is not required.

Receiving a script execution result that indicates an error, the script execution result receiving module 213 of the operating terminal 801 stops the action of the operation information obtaining module 210, to thereby cease remote control as in the first embodiment described above.

In the case where errors occur during the execution of the same script, there is a strong possibility that the errors have the same cause. Therefore, if the same error message concerning the same row number is received from two or more remote terminals 121, the script execution result receiving module 213 of the operating terminal 801 may group together the remote terminals that are experiencing the error, and transmit the failed row and subsequent rows of the script again to the remote terminals in the group, to thereby deal with the remote terminals in the group in the same manner.

The computer system may be provided with a function of automatically re-executing a script in the event of an error in which an operation target is not found, because different remote terminals may have different performance levels in drawing and other areas.

As described above, the second embodiment provides smooth remote control of a plurality of remote terminals in addition to the effects described in the first embodiment. Further, a failure in the execution of a script in some of the plurality of remote terminals does not hinder script execution in the rest of the plurality of remote terminals, which allows the computer system to continue remote control of the rest of the plurality of remote terminals.

### Third Embodiment

The third embodiment discusses an example of remote control in a computer system provided with a plurality of remote terminals in which one of the remote terminals serves as a representative terminal and is operated by conventional remote control whereas the other remote tee urinals than the representative terminal (non-representative terminals) are operated by remote control according to this invention. In the third embodiment, components and processing that have the same functions as those in the first and second embodiments described above are denoted by the same reference symbols, and descriptions thereof are omitted.

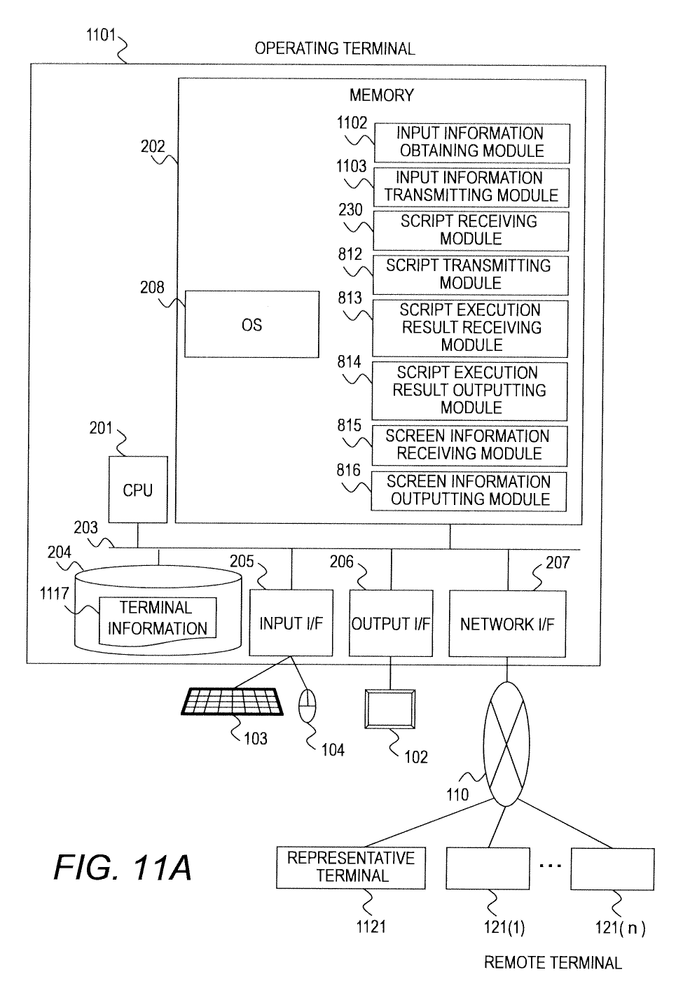

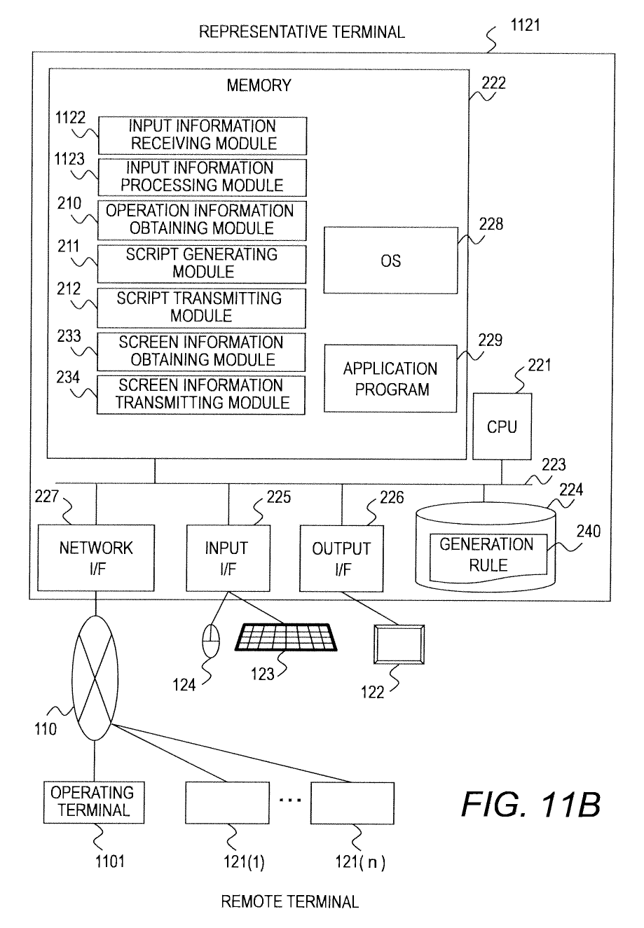

FIG. 11A is a block diagram illustrating an example of the configuration of a computer system according to the third embodiment which focuses on an operating terminal 1101.

The computer system of the third embodiment includes one operating terminal 1101, which is operated by a user, one representative terminal 1121, which is controlled remotely by the operating terminal 1101, and a plurality of remote terminals 121(1) to 121(n), which are controlled remotely by the operating terminal 1101. The operating terminal 1101, the representative terminal 1121, and the remote terminals 121(1) to 121(n) are coupled to one another via the network 110.

The operating terminal 1101 is a computer that includes the processor (CPU) 201, the memory 202, the bus 203, the non-volatile storage device 204, the input interface 205, the output interface 206, and the network interface 207. The operating terminal 1101 may be a general-purpose personal computer or a specially designed terminal. The display 102, the keyboard 103, and the mouse 104 are connected to the operating terminal 1101.

The memory 202 stores the operating system (OS) 208. In the third embodiment, the application program 209 is not executed on the operating terminal 1101 and hence there is no need to install the application program 209 in the operating terminal 1101.

The memory 202 also stores programs that constitute an input information obtaining module 1102, an input information transmitting module 1103, the script receiving module 230, the script transmitting module 812, the script execution result receiving module 813, the script execution result outputting module 814, the screen information receiving module 815, and the screen information outputting module 816. In other words, the processor 201 executes these programs to install the modules listed above.

The input information obtaining module 1102 captures input information, which is generated through the operation of the keyboard 103 and the mouse 104 by the user and is input to the OS 208. The display 102 of the operating terminal 1101 displays the same screen that is displayed on the display 122 of the representative terminal 1121. The input information transmitting module 1103 transmits input information captured by the input information obtaining module 1102 to the representative terminal 1121.

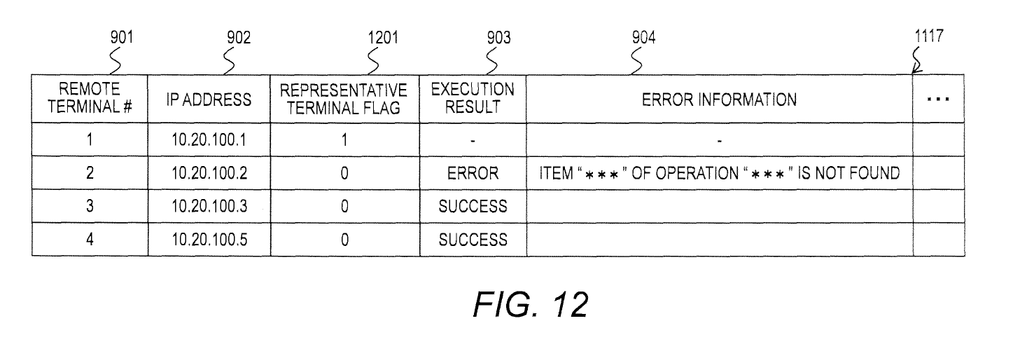

The script receiving module 230 receives the script 108 transmitted from the representative terminal 1121 and stores the received script 108 in a given storage area. The script transmitting module 812 refers to terminal information 1117 illustrated in FIG. 12 and transmits a script received by the script receiving module 230 to the plurality of remote terminals 121(1) to 121(n).

The non-volatile storage device 204 stores the terminal information 1117. The terminal information 1117 holds information of the remote terminals 121(1) to 121(n) with which the operating terminal 1101 communicates. The configuration of the terminal information 1117 is described later with reference to FIG. 12.

FIG. 11B is a block diagram illustrating an example of the configuration of the computer system according to the third embodiment which focuses on the representative terminal 1121.

The representative terminal 1121 is a computer that includes the processor (CPU) 221, the memory 222, the bus 223, the non-volatile storage device 224, the input interface 225, the output interface 226, and the network interface 227. The representative terminal 1121 may be a general-purpose personal computer or a specially designed terminal.

The display 122, the keyboard 123, and the mouse 124 are connected to the representative terminal 1121. The display 122, the keyboard 123, and the mouse 124 may not be connected to the representative terminal 1121 because the representative terminal 1121 is controlled remotely by the operating terminal 1101.

The memory 202 stores the operating system (OS) 228 and the application program 229.

The memory 202 also stores programs that constitute an input information receiving module 1122, an input information processing module 1123, the operation information obtaining module 210, the script generating module 211, the script transmitting module 212, the screen information obtaining module 233, and the screen information transmitting module 234. In other words, the processor 221 executes these programs to install the modules listed above.

The input information receiving module 1122 receives input information transmitted from the operating terminal. The input information processing module 1123 processes input information received by the input information receiving module 1122. In other words, the OS 228 and the application program 229 are executed according to the received input info illation. As a result, the OS 228 transmits a drawing command that reflects the input information and displays a screen on the display 122.

The operation information obtaining module 210 obtains a window message from input information received by the input information receiving module 1122. From the window message, the operation information obtaining module 210 extracts details of an operation, the value of the operation, and information on the target of the operation, and stores the extracted operation information 106 in a given storage area.

The script generating module 211 converts operation information extracted by the operation information obtaining module 210 into a script based on the generation rules 240, and stores the generated script 108 in a given storage area. The script transmitting module 212 transmits a script generated by the script generating module 211 to the operating terminal 1101.

The non-volatile storage device 224 stores the generation rules 240 illustrated in FIG. 4.

In the third embodiment, the representative terminal 1121 and the remote terminals 121(1) to 121(n) have different configurations as illustrated in FIG. 11B. Alternatively, the remote terminals 121(1) to 121(n) may all have the function of the representative terminal 1121. With the representative terminal 1121 and the remote terminals 121(1) to 121(n) having the same configuration, the user can designate any of the remote terminals as a representative terminal.

FIG. 12 is a diagram illustrating an example of the terminal information 1117 according to the third embodiment.

The terminal information 1117 is information referred to when the operating terminal 1101 communicates with the remote terminals 121(1) to 121(n), and contains in each entry the remote terminal number 901, the IP address 902, a representative terminal flag 1201, the execution result 903, and the error information 904. The remote terminal number 901, the IP address 902, the script execution result 903, and the error information 904 are the same as those in the terminal information 817 of the second embodiment described above, which is illustrated in FIG. 9.

The representative terminal flag 1201 indicates whether or not an remote terminal written in that entry of the terminal information 1117 is the representative terminal 1121.

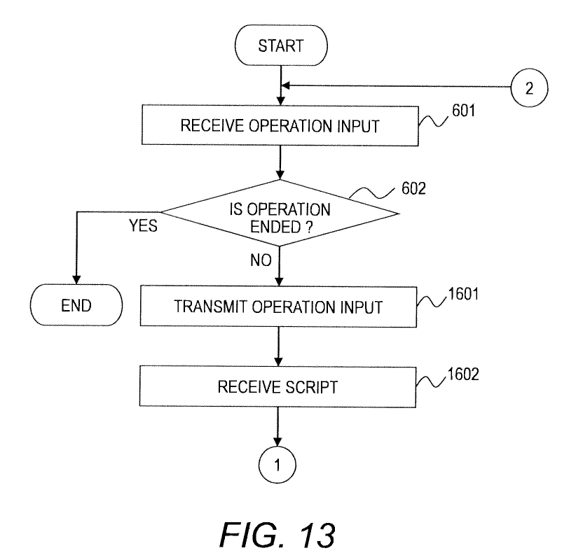

FIG. 13 is a flow chart of an example of remote control operation processing that is executed by the operating terminal 1101 according to the third embodiment.

In the computer system of the third embodiment, at the start of remote control, the screen information obtaining module 233 of the representative terminal 1121 obtains screen information of a screen that is being displayed on the display 122, and the obtained screen information is transmitted by the screen information transmitting module 234 to the operating terminal 1101. The screen information receiving module 815 of the operating terminal 1101 receives the screen information transmitted from the representative terminal 1121, and the screen information outputting module 816 displays the received screen information (displayed screen of the representative terminal 1121) on the display 102.

First, when an operation input to the keyboard 103 or the mouse 104 by the user is detected (601), the input information obtaining module 1102 captures input information from the operation input, and the input information transmitting module 1103 transmits the captured input information to the representative terminal 1121 (1601). When the input information obtaining module 1102 detects the end of the remote control operation processing, the remote control operation processing is terminated (602).

Thereafter, the script receiving module 230 receives the script 108 transmitted from the representative terminal 1121 and stores the received script 108 in a given storage area (1602).

The processing then proceeds to Step 610 of FIG. 10 to identify the IP address of an remote terminal to which the script is to be sent by referring to the terminal information 817, and to transmit the script to the identified address. The subsequent processing steps are the same as in the second embodiment described above.

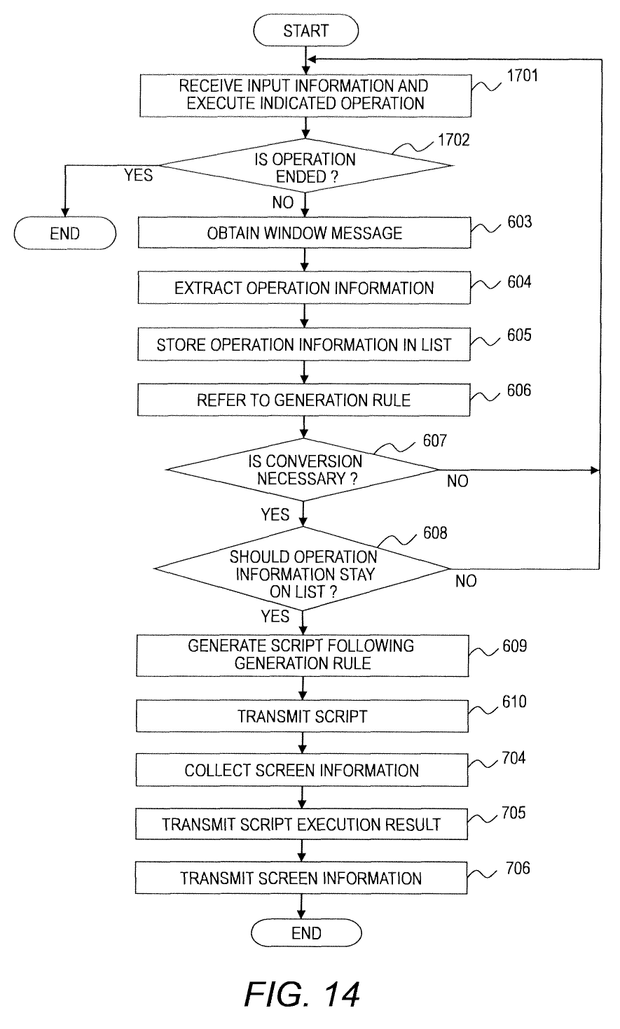

FIG. 14 is a flow chart of an example of remote control operation processing that is executed by the representative terminal 1121 according to the third embodiment.

The input information receiving module 1122 receives input information from the operating terminal 1101, and the input information processing module 1123 executes an operation indicated by the received input information (1701). When the input information processing module 1123 detects the end of the remote control operation processing, the remote control operation processing is terminated (1702).

The operation information obtaining module 210 obtains a window message from an operation input (603), extracts the operation information 106 from the obtained window message (604), and stores the extracted operation information 106 in the operation information list illustrated in FIG. 3 (605). The list generated in Step 605 may be a window-basis list or may be a single list instead of being divided by window.

The script generating module 211 refers to the generation rules 240 to determine whether or not the operation information 106 stored in the operation information list needs to be converted and whether or not this operation information should stay on the list (607 and 608). The need to convert the operation information 106 stored in the list is determined by whether or not this operation information is defined in the field for the operation information 402 in one of the generation rules 240. It is determined that the operation information 106 stored in the list should stay on the list when this operation information is defined in the field for the operation information 402 in one of the generation rules 240, and no script 403 is defined in association with this operation information.

From the operation information 106 that has been determined to need conversion and to be left on the list, the script generating module 211 generates the script 108 following the relevant generation rule 240 (609).

The script transmitting module 212 transmits the script 108 generated by the script generating module 211 to the operating terminal 1101 (610).

The screen information obtaining module 233 obtains the screen information 128 that results from executing the script (704), and the screen information transmitting module 234 transmits the obtained screen information 128 to the operating terminal 1101 (706).

The script execution result transmitting module 232 transmits the script execution result 127 to the operating terminal 1101 (705).

The script execution result transmitting module 232 may transmit the script execution result 127 one script row at a time, or may transmit the script execution result 127 at once after the execution of the entire script is finished.

The order in which Steps 704 to 706 are executed is not limited to the illustrated one, and the processing of the screen information 128 and the processing of the script execution result 127 may be executed in parallel.

FIG. 15 is a diagram illustrating an example of a screen that is displayed on the display 102 of the operating terminal 1101 according to the third embodiment.

A screen 1301 displayed on the display 102 of the operating terminal 1101 displays, among others, screen information and script execution result information of the representative terminal 1121 and the remote terminals 121(1) to 121(n). For example, the screen of the representative terminal 1121 is displayed large in an area 1303, and the screens of the remote terminals 121(1) to 121(n), which do not include the representative terminal 1121, are displayed small in areas 1305, with information of each remote terminal such as terminal information, including the IP address, and execution result information displayed in an area 1304.

An operation setting menu displaying field 1302 is provided in an upper part of the screen 1301. Buttons in the operation setting menu displaying field 1302 are operated to remotely control the remote terminals 121(1) to 121(n). For instance, by operating a “Start operation” button of the operation setting menu 1302, a remote control request is transmitted to selected remote terminals, and a message 1306 is displayed for each of the remote terminals to indicate the action state of the remote terminal. By operating an “End operation” button, a message signaling the end of remote control is transmitted to the remote terminals (NO in Step 602 of FIG. 6A and FIG. 13).

As described above, the third embodiment provides, in addition to the effects described in the first embodiment, remote control of the remote terminals 121(1) to 121(n) through the representative terminal 1121 when the target (file, application program, or the like) of an operation to be made on the remote terminals 121(1) to 121(n) cannot be operated directly by the operating terminal 1101. The third embodiment, where the operating terminal 1101 uses conventional remote control to operate the representative terminal 1121 and the representative terminal 1121 uses remote control according to this invention to operate the remote terminals 121(1) to 121(n), also reduces the amount of data transferred between terminals.

### Fourth Embodiment

As in the third embodiment described above, the fourth embodiment discusses remote control in a computer system provided with a plurality of remote terminals in which one of the remote terminals serves as a representative terminal and is operated by conventional remote control whereas the other remote terminals than the representative terminal (non-representative terminals) are operated by remote control according to this invention. However, the fourth embodiment is characterized in that the representative terminal transmits the generated script directly from the representative terminal to the other remote terminals. In the fourth embodiment, components and processing that have the same functions as those in the first to third embodiments described above are denoted by the same reference symbols, and descriptions thereof are omitted.

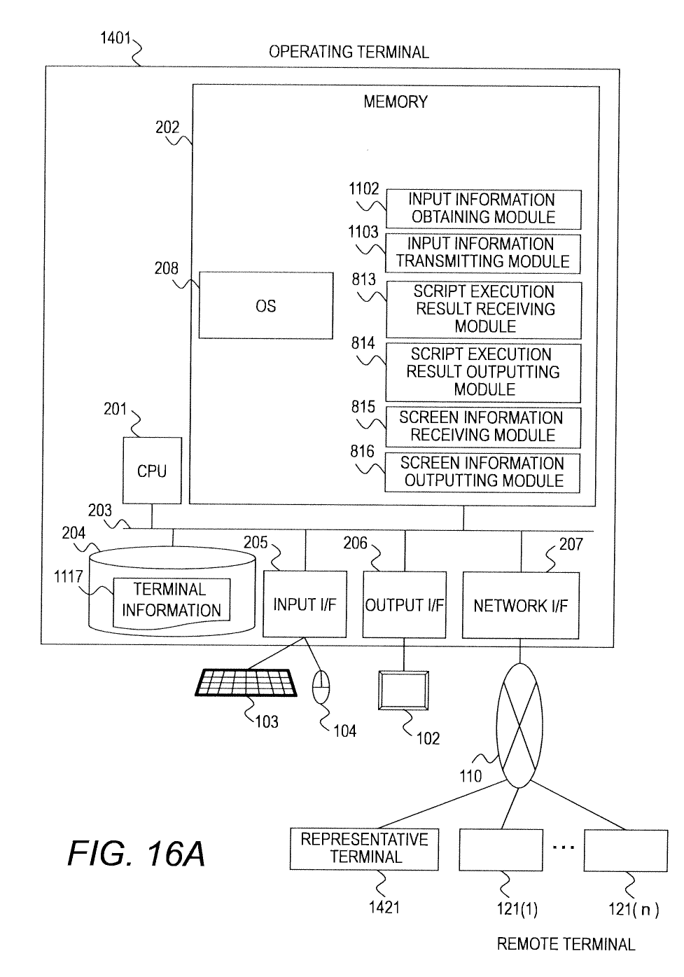

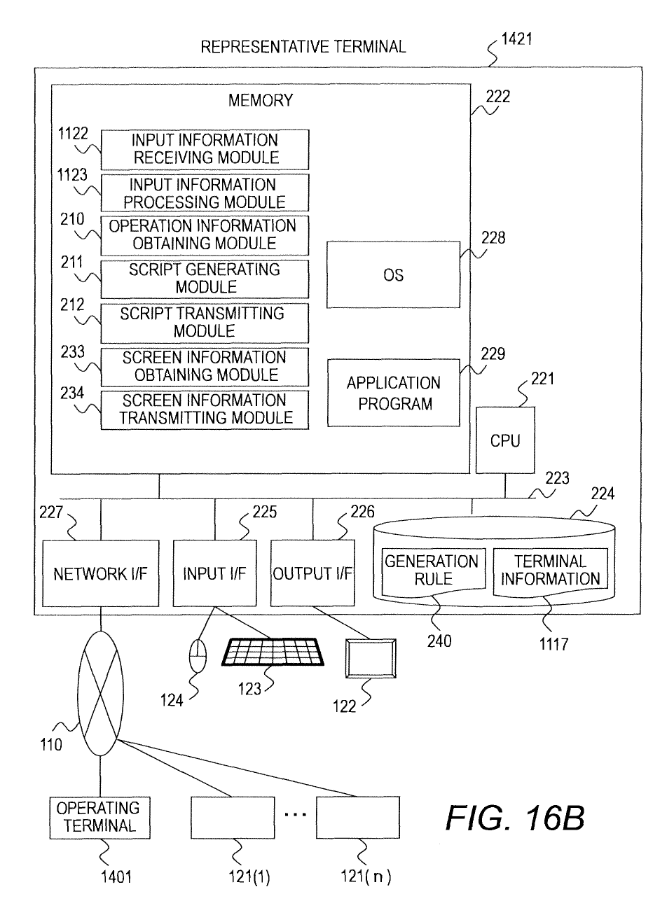

FIG. 16A is a block diagram illustrating an example of the configuration of a computer system according to the fourth embodiment which focuses on an operating terminal 1401.

The computer system of the fourth embodiment includes one operating terminal 1401, which is operated by a user, one representative terminal 1421, which is controlled remotely by the operating terminal 1401, and a plurality of remote terminals 121(1) to 121(n), which are controlled remotely by the operating terminal 1401. The operating terminal 1401, the representative terminal 1421, and the remote terminals 121(1) to 121(n) are coupled to one another via the network 110.

The operating terminal 1401 is a computer that includes the processor (CPU) 201, the memory 202, the bus 203, the non-volatile storage device 204, the input interface 205, the output interface 206, and the network interface 207. The operating terminal 1401 may be a general-purpose personal computer or a specially designed terminal. The display 102, the keyboard 103, and the mouse 104 are connected to the operating terminal 1401.

The memory 202 stores the operating system (OS) 208. In the fourth embodiment, the application program 209 is not executed on the operating terminal 1401 and hence there is no need to install the application program 209 in the operating terminal 1401.

The memory 202 also stores programs that constitute the input information obtaining module 1102, the input information transmitting module 1103, the script execution result receiving module 813, the script execution result outputting module 814, the screen information receiving module 815, and the screen information outputting module 816. In other words, the processor 201 executes these programs to install the modules listed above.

The input information obtaining module 1102 captures input information, which is generated through the operation of the keyboard 103 and the mouse 104 by the user and is input to the OS 208. The display 102 of the operating terminal 1401 displays the same screen that is displayed on the display 122 of the representative terminal 1421. The input information transmitting module 1103 transmits input information captured by the input information obtaining module 1102 to the representative terminal 1421.

The non-volatile storage device 204 stores the terminal information 1117. The terminal information 1117 holds information of the remote terminals 121(1) to 121(n) with which the operating terminal 1401 communicates.

FIG. 16B is a block diagram illustrating an example of the configuration of the computer system according to the fourth embodiment which focuses on the representative terminal 1421.

The representative terminal 1421 is a computer that includes the processor (CPU) 221, the memory 222, the bus 223, the non-volatile storage device 224, the input interface 225, the output interface 226, and the network interface 227. The representative terminal 1421 may be a general-purpose personal computer or a specially designed terminal.

The display 122, the keyboard 123, and the mouse 124 are connected to the representative terminal 1421. The display 122, the keyboard 123, and the mouse 124 may not be connected to the representative terminal 1421 because the representative terminal 1421 is controlled remotely by the operating terminal 1401.

The memory 222 stores the operating system (OS) 228 and the application program 229.

The memory 222 also stores programs that constitute the input information receiving module 1122, the input information processing module 1123, the operation information obtaining module 210, the script generating module 211, the script transmitting module 212, the screen information obtaining module 233, and the screen information transmitting module 234. In other words, the processor 221 executes these programs to install the modules listed above.

The script transmitting module 212 refers to the terminal information 1117 illustrated in FIG. 12 to transmit a script generated by the script generating module 211 to the plurality of remote terminals 121(1) to 121(n).

The non-volatile storage device 224 stores the generation rules 240 illustrated in FIG. 4 and the terminal information 1117.

In the fourth embodiment, the representative terminal 1421 and the remote terminals 121(1) to 121(n) have different configurations as illustrated in FIG. 16B. Alternatively, the remote terminals 121(1) to 121(n) may all have the function of the representative terminal 1421. With the representative terminal 1421 and the remote terminals 121(1) to 121(n) having the same configuration, the user can designate any of the remote terminals as a representative terminal.

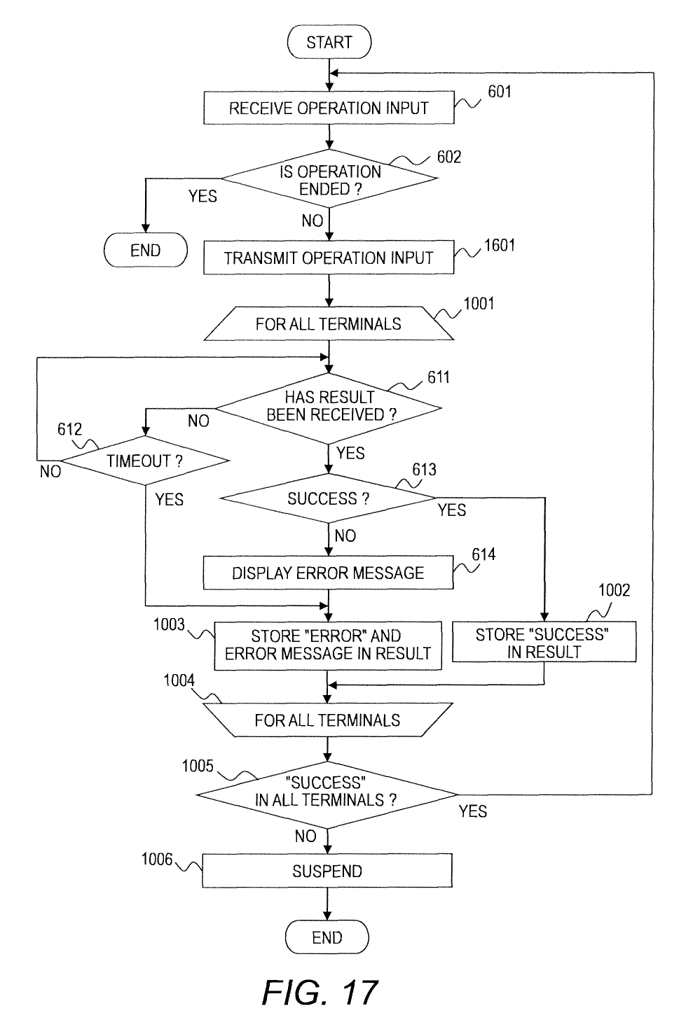

FIG. 17 is a flow chart of an example of remote control operation processing that is executed by the operating terminal 1401 according to the fourth embodiment.

In the computer system of the fourth embodiment, at the start of remote control, the screen information obtaining module 233 of the representative terminal 1421 obtains screen information of a screen that is being displayed on the display 122, and the obtained screen information is transmitted by the screen information transmitting module 234 to the operating terminal 1401. The screen information receiving module 815 of the operating terminal 1401 receives the screen information transmitted from the representative terminal 1421, and the screen information outputting module 816 displays the received screen information (displayed screen of the representative terminal 1421) on the display 102.

First, when an operation input to the keyboard 103 or the mouse 104 by the user is detected (601), the input information obtaining module 1102 captures input information from the operation input, and the input information transmitting module 1103 transmits the captured input information to the representative terminal 1421 (1601). When the input information obtaining module 1102 detects the end of the remote control operation processing, the remote control operation processing is terminated (602).

Thereafter, the script execution result outputting module 814 refers to the terminal information 1117 to identify the IP address of an remote terminal of which script execution result is to be received, and execution result receiving processing is executed for every remote terminal that has been identified. This receiving processing is the same as the receiving processing of Steps 1001, 611 to 614, and 1002 to 1004 described in the second embodiment.

When an execution result that indicates a success is subsequently received from all of the relevant remote tee annals (YES in 1005), the processing returns to Step 601 in order to obtain the next piece of operation information on the operation information list. When an execution result that indicates a failure is received from some of the remote terminals (NO in 1005), on the other hand, remote control is suspended (1006).

Processing executed by the representative terminal 1421 of the fourth embodiment is substantially the same as the remote control operation processing illustrated in FIG. 14, which is executed by the representative terminal 1121 of the third embodiment, and an illustration thereof is not provided. In Step 610 of the fourth embodiment, however, the script transmitting module 212 refers to the terminal information 1117 to identify the IP address of an remote terminal to which a script is to be sent, and transmits the script to the identified address.

As described above, the fourth embodiment, where a script is transmitted directly from the representative terminal 1421 to the remote terminals 121(1) to 121(n), reduces the amount of data transferred between terminals, in addition to providing the effects described in the third embodiment.

### Fifth Embodiment

This embodiment discusses an example of providing a computer system that includes a plurality of remote terminals with a distribution server 1501, which transmits a script to the remote terminals. In the fifth embodiment, components and processing that have the same functions as those in the first to fourth embodiments described above are denoted by the same reference symbols, and descriptions thereof are omitted.

In the example discussed in the fifth embodiment, the distribution server 1501 is added to the computer system described in the second embodiment, and the script 108 generated by the operating terminal 801 is transmitted to the remote terminals 121(1) to 121(n) by the distribution server 1501. Alternatively, the distribution server 1501 may be added to the computer system of the fourth embodiment so that the script 108 generated by the representative terminal 1421 is transmitted to the remote terminals 121(1) to 121(n) by the distribution server 1501.

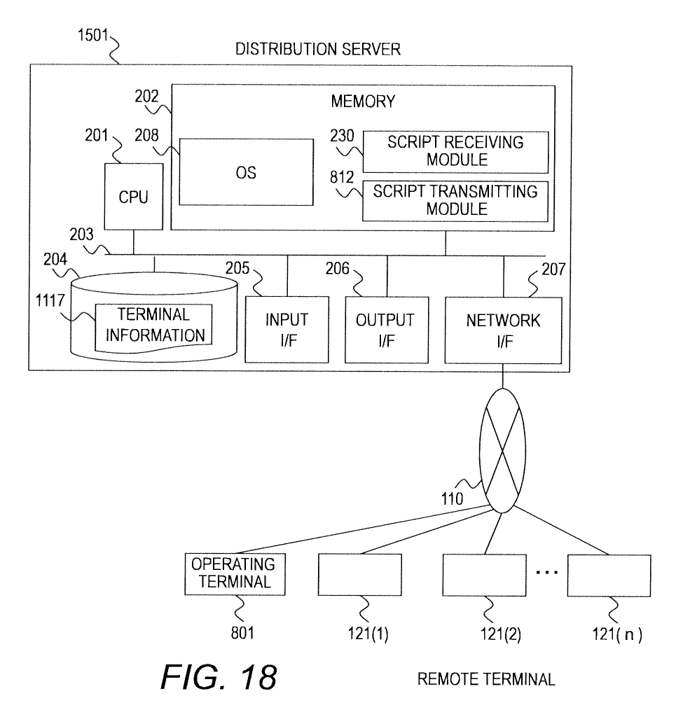

FIG. 18 is a block diagram illustrating an example of the configuration of a computer system according to the fifth embodiment which focuses on the distribution server 1501. In the fifth embodiment, components and processing that have the same functions as those in the second embodiment described above are denoted by the same reference symbols, and descriptions thereof are omitted.

The computer system of the fifth embodiment includes one operating terminal 801, which is operated by a user, a plurality of remote terminals 121(1) to 121(n), which are controlled remotely by the operating terminal 801, and the distribution server 1501, which distributes a script. The operating terminal 801, the remote terminals 121(1) to 121(n), and the distribution server 1501 are coupled to one another via the network 110.

The operating terminal 801 and the remote terminals 121(1) to 121(n) have the same configurations and functions that are described in the second embodiment, and descriptions thereof are omitted here.

The distribution server 1501 is a computer that includes the processor (CPU) 201, the memory 202, the bus 203, the non-volatile storage device 204, the input interface 205, the output interface 206, and the network interface 207.

The memory 202 is a high-speed volatile storage device such as a dynamic random access memory (DRAM). The non-volatile storage device 204 is a large-capacity non-volatile storage device such as a magnetic storage device or a flash memory.

The memory 202 stores the operating system (OS) 208. The processor 201 executes the operating system 208 to install the basic functions of the distribution server 1501.

The memory 202 stores programs that constitute the script receiving module 230 and the script transmitting module 812. In other words, the processor 201 executes these programs to install the modules listed above.

The script receiving module 230 receives the script 108 transmitted from the operating terminal 801 (or from the representative terminal 1421), and stores the received script 108 in a given storage area. The script transmitting module 812 refers to the terminal information 817 illustrated in FIG. 9 (or the terminal information 1117 illustrated in FIG. 12) to identify the IP addresses of the remote terminals 121(1) to 121(n) to which a script is to be sent, and transmits the script to the identified IP addresses.

As described above, according to the fifth embodiment of this invention where the distribution server 1501 distributes a generated script to the remote terminals 121(1) to 121(n), the load of distributing a script is dispersed, which means that the remote terminals 121(1) to 121(n) are operated smoothly even when the performance of the operating terminal 801 or the representative terminal 1401 is not high.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
an operating terminal which is operated by a user; and
at least one remote terminal which is controlled remotely by the operating terminal,
wherein the operating terminal includes a processor which executes a program, a memory which stores the program executed by the processor, a user interface, and a communication interface,
wherein the at least one remote terminal includes a processor which executes a program, a memory which stores the program executed by the processor, and a communication interface,
wherein the computer system holds a generation rule for generating a control command from operation information input by the user,
wherein the computer system further includes:
an operation information obtaining module which obtains operation information generated by the user by operating the user interface;
a command generating module which generates a control command from the obtained operation information following the generation rule; and
a command transmitting module which transmits the generated control command to the at least one remote terminal,
wherein the at least one remote terminal includes a command executing module, which executes the received control command, and an execution result transmitting module, which transmits a result of executing the received control command to the operating terminal, and
wherein the operating terminal includes an execution result receiving module, which receives the execution result transmitted from the at least one remote terminal, and determines from the received execution result whether the execution of the control command is a success or a failure.

2. The computer system according to claim 1,
wherein the operating tee urinal includes the operation information obtaining module, the command generating module, and the command transmitting module,
wherein the operation information obtaining module obtains the operation information generated by the user by operating the user interface of the operating terminal,
wherein the command generating module generates the control command from the obtained operation information, and
wherein the command transmitting module transmits the generated control command to the at least one remote terminal.

3. The computer system according to claim 1,
wherein the generation rule includes association between the operation information and the control command,
wherein, in a case where the operation information is solely about an operation on a screen and does not yield any other results than a change on the screen, the command generating module deletes the operation information, and
wherein, in a case where the operation information is about an operation that is combined with operations of other pieces of operation information to execute one processing step, the command generating module integrates a plurality of pieces of the operation information into one control command.

4. The computer system according to claim 1, wherein the control command comprises information for identifying a target of an operation, a parameter of the operation, and information about a type of the operation.

5. The computer system according to claim 1, wherein the execution result transmitted from the at least one remote terminal comprises a success or failure of the execution of the control command in the remote terminal, a place where an error has occurred, and info illation about a cause of the error.

6. The computer system according to claim 2,
wherein the computer system comprises a plurality of the remote terminals,
wherein the operating terminal holds terminal information comprising addresses of the plurality of the remote terminals which are used as destinations of the control command transmitted, and
wherein the command transmitting module refers to the terminal information to identify the address of at least one of the plurality of the remote terminals to which the control command is to be transmitted, and transmits the control command to the identified address.

7. The computer system according to claim 6,
wherein the operating terminal comprises an execution result outputting module, which processes an execution result of the control command,
wherein the execution result receiving module receives, from the at least one of the plurality of the remote terminals that is the destination of the control command, a result of executing the control command and stores the execution result of the control command for each of the at least one destination remote terminal, and
wherein the execution result outputting module determines for each of the at least one destination remote terminal whether the execution of the control command is a success or a failure.

8. The computer system according to claim 6, wherein the terminal information includes information about the address of each of the plurality of the remote terminals and a result of executing a control command in the each of the plurality of the remote terminals.

9. The computer system according to claim 1,
wherein the computer system comprises a plurality of the remote terminals and one of the plurality of the remote terminals is set as a representative terminal,
wherein the operating terminal includes:
an input information obtaining module which obtains input information generated by the user by operating the user interface; and
an input information transmitting module which transmits the obtained input information to the representative terminal,
wherein the operating terminal holds terminal information comprising addresses of the plurality of the remote terminals which are used as destinations of the control command transmitted,
wherein the representative terminal comprises the operation information obtaining module and the command generating module,
wherein the operation information obtaining module obtains operation information from the input information transmitted from the operating terminal,
wherein the command generating module generates the control command from the obtained operation information,
wherein the representative terminal transmits the control command generated by the command generating module to the operating terminal, and
wherein the operating terminal includes the command transmitting module, and the command transmitting module refers to the terminal information to identify the address of at least one of the plurality of the remote terminals to which the control command is to be transmitted, and to transmit the control command generated by the representative terminal to the identified remote terminal.

10. The computer system according to claim 1,
wherein the computer system comprises a plurality of the remote terminals and one of the plurality of the remote terminals is set as a representative terminal,
wherein the operating terminal comprises:
an input information obtaining module which obtains input information generated by the user by operating the user interface; and
an input information transmitting module which transmits the obtained input information to the representative terminal,
wherein the representative terminal comprises the operation information obtaining module, the command generating module, and the command transmitting module,
wherein the representative terminal holds terminal information comprising addresses of the plurality of the remote terminals which are used as destinations of the control command transmitted,
wherein the operation information obtaining module obtains operation information from the input information transmitted from the operating terminal,
wherein the command generating module generates the control command from the obtained operation information, and
wherein the command transmitting module refers to the terminal information to identify the address of at least one of the plurality of the remote terminals to which the control command is to be transmitted, and to transmit the control command generated by the representative terminal to the rest of the plurality of the remote terminals.

11. The computer system according to claim 1,
wherein the computer system further comprises a distribution server, which transmits the control command to a plurality of the remote terminals, and
wherein the distribution server comprises the command transmitting module, which transmits the control command generated by the command generating module to the plurality of the remote terminals.

12. A computer controlling method in a computer system,
the computer system includes: an operating terminal which is controlled by a user; and at least one remote terminal which is controlled remotely by the operating terminal,
the operating terminal including a processor which executes a program, a memory which stores the program executed by the processor, a user interface, and a communication interface,
the at least one remote terminal including a processor which executes a program, a memory which stores the program executed by the processor, and a communication interface,
the computer system holding a generation rule including a rule for generating a control command from operation information input by the user,
the computer controlling method including the steps of:
obtaining operation information generated by the user by operating the user interface;
generating a control command from the obtained operation information following the generation rule;
transmitting the generated control command to the at least one remote terminal;
executing, by the at least one remote terminal, the received control command and transmitting a result of executing the received control command to the operating terminal; and
receiving, by the operating terminal, the execution result transmitted from the at least one remote terminal and determining from the received execution result whether the execution of the control command is a success or a failure.

13. The computer controlling method according to claim 12,
wherein the obtaining operation information generated by the user by operating the user interface is performed by the operating terminal,
wherein the generating a control command from the obtained operation information following the generation rule is performed by the operating terminal, and
wherein the transmitting the generated control command to the at least one remote terminal is performed by the operating terminal.

14. The computer controlling method according to claim 12,
wherein the generation rule includes association between the operation information and the control command, and
wherein the step of generating a control command includes the steps of:
deleting, in a case where the operation information is solely about an operation on a screen and does not yield any other results than a change on the screen, the operation information; and
integrating, in a case where the operation information is about an operation that is combined with operations of other pieces of operation information to execute one processing step, a plurality of pieces of the operation information into one control command.

15. The computer controlling method according to claim 13,
wherein the computer system includes a plurality of the remote terminals,
wherein the operating terminal holds terminal information comprising addresses of the plurality of the remote terminals which are used as destinations of the control command transmitted, and
wherein the step of transmitting the generated control command includes the step of identifying, through reference to the terminal information, the address of at least one of the plurality of the remote terminals to which the control command is to be transmitted, and transmitting the control command to the identified address.

16. The computer controlling method according to claim 15, further including the steps of:
receiving, by the operating terminal, from the at least one of the plurality of the remote terminals that is the destination of the control command, a result of executing the control command, and storing the execution result of the control command for each of the at least one destination remote terminal; and
determining, by the operating terminal, for each of the at least one destination remote terminal, whether the execution of the control command is a success or a failure.

17. The computer controlling method according to claim 12,
wherein the computer system comprises a plurality of the remote terminals,
wherein the operating terminal holds terminal information comprising addresses of the plurality of the remote terminals which are used as destinations of the control command to be transmitted, and
wherein the computer controlling method further including the steps of:
setting, by the operating terminal, one of the plurality of the remote terminals as a representative terminal;
obtaining, by the operating terminal, input information which is generated by the user by operating the user interface;
transmitting, by the operating terminal, the obtained input information to the representative terminal;
obtaining, by the representative terminal, operation information from the input information transmitted from the operating terminal;
generating, by the representative terminal, a control command from the obtained operation information, following the generation rule;
transmitting, by the representative terminal, the generated control command to the operating terminal;
identifying, by the operating terminal, through reference to the terminal information, the address of at least one of the plurality of the remote terminals to which the control command is to be transmitted; and
transmitting, by the operating terminal, the control command generated by the representative terminal to the identified remote terminal.

18. The computer controlling method according to claim 12,
wherein the computer system comprises a plurality of the remote terminals,
wherein one of the plurality of the remote terminals is set as a representative terminal and the representative terminal holds terminal information including addresses of the plurality of the remote terminals which are used as destinations of the control command to be transmitted, and
wherein the computer controlling method further comprises:
obtaining, by the operating terminal, input information which is generated by the user by operating the user interface;
transmitting, by the operating terminal, the obtained input information to the representative terminal;
obtaining, by the representative terminal, operation information which is generated by the user by operating the user interface;
generating, by the representative terminal, the control command from the obtained operation information, following the generation rule;
identifying, by the representative terminal, through reference to the terminal information, the address of at least one of the plurality of the remote terminals to which the control command is to be transmitted; and
transmitting, by the representative terminal, the control command generated by the representative terminal to the rest of the plurality of the remote terminals.

19. The computer controlling method according to claim 12,
wherein the computer system comprises a distribution server, which transmits the control command to a plurality of the remote terminals, and
wherein the distribution server transmits the generated control command to the plurality of the remote terminals.
